(19) United States
(12) Patent Application Publication
(10) Pub. No.: US 2014/0282068 A1
(43) Pub. Date: Sep. 18, 2014

(54) SYSTEMS AND METHODS FOR TRANSFERRING OF OBJECTS AMONG MOBILE DEVICES BASED ON PAIRING AND MATCHING USING ACTIONS AND/OR GESTURES ASSOCIATED WITH THE MOBILE DEVICE

(71) Applicant: SingTel Idea Factory Pte. Ltd., Singapore (SG)

(72) Inventors: Shany Levkovitz, Ramat Gan (IL); Michael C. Winograd, Nir-Zevi (IL); Choy M. Lit, Singapore (SG); Hwang J. Joon, Singapore (SG); Tomer Galon, Raanana (IL)

(73) Assignee: SingTel Idea Factory Pte. Ltd., Singapore (SG)

(21) Appl. No.: 14/177,763

(22) Filed: Feb. 11, 2014

Related U.S. Application Data
(60) Provisional application No. 61/788,154, filed on Mar. 15, 2013.

(51) Int. Cl. H04L 29/08; G06F 3/0482; G06F 3/0488

(52) U.S. Cl. CPC H04L 67/10; G06F 3/0488; G06F 3/0482
USPC 715/748

(57) ABSTRACT

Systems and methods to facilitate the transfer of one or more objects from a first mobile device to another mobile device(s) proximate the first mobile device based on pairing or matching among the mobile devices, in which transfer among mobile devices is accomplished using hand-based gestures on the mobile devices.

### RELATED APPLICATIONS

This application claims the benefit of U.S. Provisional Patent Application No. 61/788,154, filed Mar. 15, 2013 and entitled “Systems and methods for transferring objects among mobile devices based on pairing and matching,” which is incorporated herein by reference.

Recent years have seen the increasing popularity of mobile devices, such as Apple's iOS-based devices and Google's Android-based devices, and the exponential growth of apps available to be downloaded and run on such mobile devices. Unlike other traditional computing devices, such as the desktops and laptops, mobile devices or smart phones are often equipped with the capability to identify their own physical location via services such as GPS. Furthermore, most of the smart phones are equipped with touchscreens that allow mobile devices to accept and recognize hand/finger gestures performed by users. These hand/finger gestures are further interpreted as instructions and commands to organize, manage, and run the apps and/or manipulate data/objects on the mobile devices. With the popularity of the mobile devices, approaches have been proposed to transfer data between different mobile devices that are adjacent to each other. For example, U.S. Pat. No. 8,391,719 discloses pairing two mobile devices based on hand gestures, i.e., swipes, performed across the two mobile devices, wherein the swipes by the hand/fingers are recognized by the reflection of signals sent from sensing assemblies on the two mobile devices, similar to infrared signals from transceivers. Such an approach, however, requires equipping both mobile devices with specific types of sensing assemblies and swiping must be across the sensing assemblies on both mobile devices with certain types of gestures in order to pair and transfer data between them. Consequently, such an approach is error-prone or even infeasible especially when the two mobile devices are not placed next to each other. Another approach as disclosed by U.S. Patent Application Publication Number 2013/0085705 allows a user to move an object displayed on one mobile device to another adjacent device by swiping a finger(s) across both mobile devices. Such across-the-device swiping requires that the two mobile devices be physically placed next to each other in order to avoid errors in pairing the devices. Furthermore, it requires that the swipe must be across both mobile devices, which limits the practical usability of such approach. Mobile devices are also increasingly being used to conduct financial transactions with banks and other financial institutions. In some cases, an external device such as a magnetic card reader can be attached to a mobile device and utilized to receive a payment from an individual who would swipe a credit or debit card through the card reader. In a non-limiting example, if one person owes another person money for a debt, the person may pay off the debt owed to the other person by swiping a credit card or a debit card through a card reader attached to the mobile device of that person. However, such a person-to-person financial transaction can only be done via credit or debit card, and such transactions require utilizing external card readers attached to the mobile device. It would be desirable for the users to be able to transfer money between their accounts directly without requiring an additional, external device. It would also be advantageous to enable users to transfer and exchange data items, e.g., files, videos, photos, contact information, and the like, back and forth via a simple hand/finger gesture(s) on the touchscreen of one of the mobile devices. The foregoing examples of the related art and limitations related therewith are intended to be illustrative and not exclusive. Other limitations of the related art will become apparent upon a reading of the specification and a study of the drawings.

In a first aspect to the present invention, a system for transferring an object between mobile devices is disclosed. In some embodiments, the system comprises a pair-matching engine that is adapted to identify a second mobile device associated with a second user in proximity with a first mobile device associated with a first user, wherein the second mobile device is ready to conduct a transaction with the first mobile device; a first user interaction engine running on a first mobile device associated with a first user that is adapted to enable the first user to initiate the transaction to transfer an animated and/or customizable object displayed on the first mobile device, e.g., a virtual software object running and being displayed on the mobile device, a mobile app downloaded to the mobile device, a data payload or file stored in the mobile device, any other type of electronic information that can be communicated between the mobile devices, and the like, to the second mobile device via a gesture on a touchscreen, e.g., a swipe, tap, touch, panning, bump, drag and drop by one or more fingers of the first user on the object displayed on the touchscreen, or motion using of the first mobile device; a second user interaction engine running on the second mobile device associated with a second user that is adapted to accept visually on a screen of the second mobile device the object transferred from the first mobile device and to enable the second user to confirm completion of the transaction. Preferably, the object may be uploaded from a server before being downloaded to the second mobile device from the server; although, in the alternative, the object may be transferred directly from the first mobile device to the second device. Advantageously, the first user interaction engine may also enable the first user to manipulate and to interact with the object via a hand/finger gesture on the touchscreen.

In another embodiment, the system may further comprise a mobile transaction engine that is adapted to update relevant records of the first and second users associated with the first and the second mobile devices after the transaction is complete. In yet another embodiment, the first user interaction engine and/or the second user interaction engine may collect information, e.g., locations of the users' mobile devices, the users' gestures/motion on the mobile devices, and the timestamps of the users' gestures/motion, from the first and/or second users as well as from their associated mobile devices for identifying the second mobile device paired and matched with the first mobile device. In still another embodiment, the first user interaction engine and/or the second user interaction engine may adjust the accuracy of the location information of the mobile devices used for pairing and matching of the mobile devices based on the locations of the first and/or second mobile devices.

In some variations of the embodiments, the pair-matching engine may be adapted to: utilize information collected from the mobile devices to calculate a user vector for each of the mobile devices for pairing and matching purpose; identify the second mobile device by calculating the distance between the first and the second mobile devices based on the information collected from the mobile devices; to identify the second mobile device by conducting timeframe analysis on the data collected from the mobile devices to calculate the exact time when the gestures/motions are made on the mobile devices; to identify the second mobile device by recognizing different types of user gestures made on or motions made with the mobile devices and their attributes to establish rules for a successful match between the two mobile devices; compare directions of the hand gestures/motions made by the first and/or the second user to determine the type of action to be taken on the object; dynamically configure tolerance parameters and/or error margins for matching of the mobile devices based on current status of the mobile devices; identify the second mobile device; identify the second mobile device in a dense transfer environment where there are many transfers taking place at the same location during the same time window; and identify more than one possible matching mobile devices associated with multiple users that match with the first mobile device. Preferably, the user interaction engine may be adapted to present a list of the matching mobile devices to the first user and to enable the sender to choose one or more mobile devices from the list to proceed with the transfer of the object.

In a second aspect of the present invention, a method of for transferring an object between mobile devices is disclosed. In some embodiments, the method comprises identifying a second mobile device that is associated with a second user and that is ready to conduct a transaction with a first mobile device that is associated with a first user and that is in proximity with a second mobile device; enabling the first user to initiate the transaction to transfer an object displayed on the first mobile device from the first mobile device to the second mobile device via a hand gesture on a touchscreen or via a motion with the first mobile device; accepting visually the object transferred from the first mobile device on a screen of the second mobile device; and enabling the second user to confirm completion of the transaction. In some variations, first user may be enabled to manipulate and interact with the object via a hand gesture on the touchscreen. Preferably, transferring the object may occur by uploading the object to a server before downloading it to the second mobile device from the server.

In yet another embodiment, the method further may comprise updating relevant records of the first and second users associated with the first and the second mobile devices after the transaction is complete. In still another embodiment, the method includes collecting information, e.g., locations of the users' mobile devices, the users' gestures on or motions with the mobile devices, and the timestamps of the users' gestures/motions, from the first and/or second users as well as from their associated mobile devices for identifying the second mobile device paired and matched with the first mobile device.

In some variations, the method may include adjusting accuracy of the location information of the mobile devices used for pairing and matching of the mobile devices based on the locations of the first and/or second mobile devices; utilizing information collected from the mobile devices to calculate a user vector for each of the mobile devices for pairing and matching purpose; identifying the second mobile device by calculating the distance between the first and the second mobile devices based on the information collected from the mobile devices; identifying the second mobile device by conducting timeframe analysis on the data collected from the mobile devices to calculate the exact time when the gestures/motions are made on the mobile devices; identifying the second mobile device by recognizing different types of user gestures/motions made on or with the mobile devices and their attributes to establish rules for a successful match between the two mobile devices; comparing directions of the gestures/motions made by the first and/or the second user to determine the type of action to be taken on the object; dynamically configuring tolerance parameters and/or error margins for matching of the mobile devices based on current status of the mobile devices; identifying the second mobile device; identifying the second mobile device in a dense transfer environment where there are many transfers taking place at the same location during the same time window; identifying more than one possible matching mobile devices associated with multiple users that match with the first mobile device; and/or presenting a list of the matching mobile devices to the first user and enabling the sender to choose one or more mobile devices from the list to proceed with the transfer of the object.

### BRIEF DESCRIPTION OF THE DRAWINGS

FIG. 1 depicts an example of a system diagram to support transferring of virtual objects between mobile devices.

FIG. 2 depicts an example of a flowchart of a process to support transferring of virtual objects between mobile devices.

FIG. 3 depicts a non-limiting example of transferring an animated object of a flying butterfly from a first mobile device associated with a sender to a matching second mobile device associated with a recipient.

FIG. 4 further depicts a non-limiting example of implementation of the engines depicted in FIG. 1.

FIG. 5 depicts a non-limiting example of an implementation of FIG. 1 to support transactions between mobile devices via hand gestures.

FIG. 6 depicts an example of a flowchart of a process to support financial transactions among mobile devices via hand gestures.

FIGS. 7A-7N depict another non-limiting example of a step-by-step process of conducting a financial transaction between a sender and a recipient via their associated mobile devices.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to facilitate the transfer of one or more objects from one mobile device to one or more other mobile devices based on pairing or matching among the mobile devices. As referred to hereinafter, an object can be—but is not limited to—one of: virtual software object running and being displayed on the mobile device, a mobile app downloaded to the mobile device, such as an app downloaded from Apple's or Google's App store, a data payload or file stored in the mobile device, wherein such data payload includes but is not limited to, multimedia file, video, music, image/photo, URL, contact information or any other type of electronic information that can be communicated between mobile devices.

Unlike current approaches, the proposed approach adopts multi-dimensional measurements for accurate identification of the pairing device and it allows the user to perform some action with or gesture, e.g., swipe, on either one of the mobile devices to initiate the transaction, which is especially useful when the two mobile devices are not placed close enough to each other for a continuous hand/finger swipe across the touchscreens of both of them. Such approach can be applied in a wide range of contexts, which include but are not limited to, transferring money and/or files among mobile devices using a gesture(s), e.g., gestures using a pointer, a stylus, a fingertip, and the like as well as hand-based gestures, on or proximate the screens or other portions of the mobile devices. The pairing of the mobile devices may also be used for the creation of a temporary closed network to communicate, share data/tether, synchronize data, exchange information, and/or participate in multiplayer gaming based on time and locations.

FIG. 1 depicts an example of a system diagram to support transferring of virtual objects between mobile devices. Although the diagram depicts components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

Referring to FIG. 1, the system 100 may include a plurality of user interaction engines 102 running on a mobile device associated with a user and a pair-matching engine 104. Further, the system may also include a mobile transaction engine 106 and a user record database 110. As used herein, the term “engine” refers to software, firmware, and hardware, a combination of the same or other component(s) that is used to effectuate a purpose. Typically, the engine may include software instructions that are stored in non-volatile memory (also referred to as secondary memory). When the software instructions are executed, a processor may be adapted to load a subset of the software instructions into memory (also referred to as primary memory). The processor may be further adapted to execute the software instructions that are stored in primary memory. The processor may be a shared processor, a dedicated processor or a combination of shared and dedicated processors. A typical program executed may include calls to hardware components (such as I/O devices), which typically require the execution of drivers. The drivers may or may not be considered part of the engine, but the distinction is not critical. As used herein, the term “database” is used broadly to include any known or convenient means for storing data, whether centralized or distributed, relational or otherwise.

In the example of FIG. 1, each of the engines may run on one or more hosting devices (a “host”). Here, a host can be a computing device, a communication device, a storage device, a mobile device or any electronic device capable of running a software component. For non-limiting examples, a computing device can be—but is not limited to—a laptop PC, a desktop PC, a tablet PC, an iPod, an iPhone, an iPad, Google's Android device, a PDA, and/or a server machine. A storage device can be—but is not limited to—a hard disk drive, a flash memory drive, or any portable storage device. A mobile device can be a mobile communication device such as a mobile phone, a smart phone, an iPhone, an iPod, an iPad, Google's Android-based device, or Microsoft's Window phone.

In the example of FIG. 1, each of the engines 102 running on a mobile device may include a communication interface (not shown), which is a software component that enables the engines 102 to communicate with each other following certain communication protocols, such as TCP/IP protocol, over one or more communication networks 109, e.g., the Internet, an intranet, a wide area network (WAN), a local area network (LAN), a wireless network, a Bluetooth network, a WiFi network, a mobile communication network, and the like. The physical connections of the network 109 and the communication protocols are well known to those of skill in the art.

In some embodiments, instead of running on a mobile device or a web-enabled client device, each of the engines 102 may be deployed in a cloud and operate and communicate with each other through services provided by the cloud. Such cloud-based deployment ensures scalability, high-availability, robustness, data storage, and backups of the system 100.

Advantageously, the user interaction engine 102 running on a mobile device 105 may be configured to interact with a user 103 via a user interface that accepts non-textual input, such as an action(s) performed with the mobile device 105, gestures, e.g., gestures using a pointer, a stylus, a fingertip, and the like as well as hand-based gestures, via the touch screen of the mobile device 105, as well as textual input. For illustrative purposes only, typically, the non-textual hand-based gesture can be—but is not limited to—a swipe, a tap, a touch, a panning, a bump, a drag-and-drop, e.g., using one or more fingers of the user on a specific object, item, or icon presented on the touchscreen, and the like. The user interaction engine 102 may further be adapted to present an object, e.g., a butterfly, a coin, a wallet, and so forth, to the user 103, which a user 103 may manipulate and interact with, e.g., via a hand/finger gesture on the touchscreen.

### Matching and Pairing of Mobile Devices

The user interaction engine 102 may be adapted to collect information and data from the user 103 as well as from the associated mobile device 105 for the purpose of matching and pairing of a first mobile device 105a with another mobile device(s) 105b. Although only two mobile devices 105a, 105b are shown in FIG. 1, this is done for illustrative purposes and ease of description only. Furthermore, in the description below, a first 105a and a second mobile device 105b are described. Those of ordinary skill in the art can appreciate that the “second” mobile device 105b can be one or more mobile devices that are not the first mobile device 105a. Indeed, according to the present invention, there can be a multiplicity of mobile devices 105.

The collected information and data may include—but are not limited to—the location of each user's mobile device 105a, 105b, the users' actions/gestures with, on or near the devices 105a, 105b, unique identifiers associated with the mobile devices 105a, 105b, the timestamps of such actions/gestures (as discussed below), and so forth. In some embodiments, information collected by the user interaction engine 102 includes location data of the mobile device 105a, 105b. Such location data are needed and used to confirm that the first mobile device 105a and a second mobile device(s) 105b are proximate each other. Preferably, the user interaction engine 102 is structured and arranged to collect location data in a timely fashion via any one or more of the following positioning methods: Global Positioning System (GPS); Cell-ID; via Wi-Fi networks; and/or via matching with nearby Wi-Fi SSID, and comparing the Wi-Fi SSID with that of the second device 105b.

In certain situations in which high accuracy of the mobile device 105 locations is required, for example at conferences or in heavily-populated areas, e.g., shopping malls, markets, sports facilities, and the like, the pair-matching engine 104 may be adjusted to raise the accuracy of the location identification to the maximum level and the pair-matching engine 104 may be allowed to take longer time than usual to find a match.

In some embodiments, information collected by the user interaction engine 102 includes a timestamp of a user 103 action/gesture made on, near or with the mobile device 105. Such timestamp information may be collected and used by the pair-matching engine 104 to determine if actions are taken by the two different users 103a, 103b on their respective first 105a and second mobile devices 105b at or nearly at the same time or within a certain, pre-defined period of time.

In some embodiments, the information collected by each user interaction engine 102 may include data from the sensor(s) of the mobile device 105 as well as recognized actions/gestures. For a non-limiting example, the user interaction engine 102 may record the direction of a swipe on the touchscreen of the mobile device 105 by the user 103 and send such information to the pair-matching engine 104 for further processing.

In some embodiments, the information collected by the user interaction engine 102 may include a unique identifier of the mobile device 105, which can be used to uniquely identify the mobile device 105 as well as the user 103 associated with the mobile device 105. In some embodiments, such unique device identifier may be further integrated with other user/device identifying information, such as the user's identification and/or authentication information on a social network for the purpose of user/device identification.

The pair-matching engine 104 utilizes information collected and sent by user interaction engines 102 to calculate a user vector for each of the mobile devices 105a, 105b. The pair-matching engine 104 may be adapted to establish a match between the two mobile devices 105a, 105b by comparing the two user vectors to confirm that both users 103a, 103b fit within multiple matching dimensions that include but are not limited to a distance buffer, a time window, gesture compatibility, and so forth, as discussed below.

In some variations, the pair-matching engine 104 may be adapted to calculate the distance between the mobile devices 105a, 105b of the two users 103a, 103b based on the information collected and supplied by user interaction engine 102 running on the devices 105a, 105b. In some embodiments, pair-matching engine 104 may use, for example, the Haversine formula, database GEO functions, and the like to calculate the great circle between two points, which is the shortest distance over the earth's surface, taking into consideration the spherical earth. If the calculated distance between the two mobile devices falls within a pre-specified distance buffer/window, the two mobile devices 105a, 105b are considered successfully paired or matched.

In other variations, the pair-matching engine 104 may conduct timeframe analysis on the data collected from the mobile devices 105a, 105b by the user interaction engine 102 and may be adapted to utilize network latency data to unify the timestamps collected to calculate the exact time when the actions/gestures are made with, on or near the mobile devices 105a, 105b. In some embodiments, in order to find a match between two actions/gestures conducted by two different users 103a, 103b on two different devices 105a, 105b as well as to ascertain the sequence of the two actions/gestures, the system can be adapted to determine whether or not the timestamps of both actions/gestures fall within the same timeframe, e.g., using the pair-matching engine 104. For example, the system 100 may configure the duration of the timeframe, i.e., the time window or time period, to a non-limiting example of 1-15 seconds. The pair-matching engine 104 may further configure the matching mechanism to find a match between two mobile devices 105a, 105b even if the “sender” 103a of an object made his/her action/gesture on the first mobile device 105a after the “receiver” or “recipient” 103b of the object made his/her action/gesture on the second mobile device 105b. For the sake of simplicity in describing this invention, the transaction participant that enters an amount and makes an earlier action/gesture is presumed to be the “sender.” However, those of ordinary skill in the art can appreciate that there may be other scenarios for other transactions that may use the devices and methods described herein; although the “sender” may not be the first participant to enter a transfer amount or perform an action/gesture on his/her mobile device first.

In still other variations, the pair-matching engine 104 supports and recognizes different types of user actions/gestures made on, near or with the mobile devices 105 and their attributes for action/gesture matching to establish rules for a successful match between different mobile devices 105a, 105b. In a non-limiting example, the pair-matching engine 104 may create a rule that a swipe by a first user 103a, e.g., sender of an object or action, from left to right on the touchscreen of the first mobile device 105a can be successfully received and matched only by a swipe by a second user 103b, e.g., receiver of the object or action, from right to left on the touchscreen of a second mobile device 105b. Furthermore, a high confidence match can be enabled if the two devices 105a, 105b are disposed tightly adjacent to one another so that the pair-matching engine 104 can consider the vector created on both mobile devices 105a, 105b and verify that they align to the same unique swipe action. Note that the actions/gestures used by the sender 103a and by the receiver 103b may be different.

In further variations, the pair-matching engine 104 may compare the directions of both actions/gestures by the sender 103a and the receiver 103b of an action/object and determine the type of action to be taken on the object, e.g., animation the user interaction engine 102 should render on the receiver's mobile device 105b. For example, if the sender 103a swipes from left to right on his/her mobile device 105a, the object, e.g., an animated butterfly, may exit, i.e., fly out, from the right side of the sender's device 105a. Similarly, if the receiver 103b swipes from right to left on his/her mobile device 105b, the object may enter, i.e., fly in, from the right side of the receiver's device 105b.

Advantageously, the pair-matching engine 104 can dynamically configure the three match dimensions to fine-tune the tolerance parameters and/or error margins for matching of the mobile devices 105 based on the current status of the devices 105. Specifically, in the case of matching based on the distance buffer between the mobile devices 105, the pair-matching engine 104 may adjust the distance buffer used for the matching between the mobile devices 105. In the case of matching based on matching of the timestamps of the users' actions, the pair-matching engine 104 may adjust the time window used to identify the matching of the two timestamps. In the case of matching based on the sequence of the two actions/gestures by the users, the pair-matching engine 104 may define the sequence of the gestures for a valid match, e.g., sender's first, receiver's first, or indifferent. In the case of matching based on the corresponding types and directions of the two gestures by the users, the pair-matching engine 104 may define a rule that only a certain action/gesture sequence will result in a match. For example, if the sender 103a swiped from right to left, the receiver 103b must swipe from right to left as well.

In some embodiments, the pair-matching engine 104 may be adapted to rely on less than all three of the dimensions discussed above for the matching of two different mobile devices 105a, 105b, especially in instances in which data for one of the three dimensions are not available. For example, if location information is not available from either or both of the participating users 103a, 103b, the pair-matching engine 104 may fall back and rely only upon time window and action/gesture matching.

In some embodiments, the pair-matching engine 104 may be adapted to utilize near field communication (NFC) technique for pairing and matching of mobile devices 105. NFC is a set of standards for two smartphones and similar mobile devices to establish radio communication with and between each other by touching them together or bringing them into close proximity, usually no more than a few centimeters.

In other embodiments, the pair-matching engine 104 may be adapted to be able to determine the matching behavior between the two mobile devices 105a, 105b in a dense transfer environment where there are many transfers taking place at the same location during the same time window. For example, if the pair-matching engine 104 identifies that there are many attempts between two mobile devices 105a, 105b to match and transfer an object in a small physical space, e.g., a conference, a party, and the like, the pair-matching engine 104 may increase the tolerance of the matching in order to increase the chance of successful matching between the two devices 105a, 105b. In order to make the transfer reliable—especially in a dense transfer environment—the pair-matching engine 104 may configure the behavior of the matching mechanism to the default behavior, which returns the first matching device found and identified. The pair-matching engine 104 may also configure the matching behavior to return a no match message, in which case the user interaction engine 102 may be adapted to ask the user 103 to repeat the action/gesture. The system 100 also may be adapted to conduct a second polling and/or to return a list of all potential matches from which the sender 103a may select a desired receiver 103b as described hereinbelow.

Once the first 105a and second mobile devices 105b are matched and paired, user interaction engine 102 enables the user 103a (sender) associated with the first mobile device 105a to transfer a virtual/animated object, data or application to the pairing second mobile device 105b associated with the second user 103b (receiver) via an action/gesture on the object to be transferred on the first mobile device 105a. The transfer is completed using a server, e.g., the mobile transaction engine 106, whereby the virtual/animated object, data, and/or application transferred is uploaded on the mobile transaction engine 106 from the first mobile device 105a and then downloaded from the mobile transaction engine 106 onto the second mobile device 105b. Once the object, data, and/or application is confirmed to have been transferred to and accepted by the receiver 103b, the transaction is complete and the mobile transaction engine 106 may proceed to update the records, e.g., financial accounts, associated with the first 103a and the second users 103b. Optionally, the object, data, and/or application may be transferred directly from the first mobile device 105a to the second device 105b without any uploading or downloading at or by the server. In such instances, the mobile transaction engine 106 may also be notified of the transfer, after which, the mobile transaction engine 106 may proceed to update the records associated with the first 103a and the second users 103b.

FIG. 2 provides a flowchart 200 of an exemplary process for performing a pair match and for transferring a virtual object(s) between mobile devices. Although, for the purpose of illustration, functional steps are depicted in a particular order, the process is not limited to any particular order or arrangement of steps. Those skilled in the relevant art can appreciate that the various steps portrayed in this figure could be omitted, rearranged, combined, and/or adapted in various ways.

For the purpose of illustration, the process described will be for transferring money from a first, i.e., sender's, account to a second, i.e., receiver's, account. The “object” in this example, then, is virtual money. Referring to FIG. 2, the flowchart 200 may begin at blocks 201 and 202, in which, respectively, a user 103a, i.e., a “sender,” having a first mobile device 105a, initiates a request to transfer money and a second user 103b, i.e., a “receiver,” having a second mobile device 105b that is in proximity to the first mobile device 105a, initiates a request to receive money from the sender 103a. Preferably, each request 201, 202 can be initiated on a mobile device 105 using an action/gesture, e.g., a hand gesture (by swiping the respective screens of the mobile devices 105). Each request 201, 202 is individually transmitted through the network 109 to the pair-matching engine 104, which registers the sender 203 and the receiver(s) 204. In the case of the latter, as part of the registration step 204, the pair-matching engine 104 provides each receiver 103b with confirmation that the receiver 103b has been registered, which is to say, the registered receiver 103b would now be able to receive the object transferred.

The pair-matching engine 104 then proceeds to gather or collect potential, valid receivers 204, in which “validity” may be deemed in terms of distance, time frame, and/or actions/gestures by the users 103, before presenting to the sender 103a a compilation of all valid receivers 206, which may include a single receiver 103b, multiple receivers or no receiver at all. In some embodiments, the pair-matching engine 104 is able to identify multiple mobile devices 105b associated with receivers 103b who match with the mobile device 105a of the sender 103a in terms of one or more of: distance, time frame, and/or actions/gestures by the users 103. Preferably, the collection step 204 lasts for a pre-configured or configured time window, e.g., three (3) seconds, and, further, requires that the proximity of the mobile devices 105a, 105b conforms to a pre-defined distance buffer 205. The pre-defined distance buffer is the maximum allowable distance, e.g., 1000 meters, between the sender 103a and the receiver 103b.

Using the compiled list of valid receivers, the sender 103a personally identifies the recipient(s) 103b of the transfer 208, transmitting his/her selection to the pair-matching engine 104. In some variations of the embodiment, the sender 103a may be constrained to confirm a specific receiver 103b within a pre-defined time window, e.g., 20 seconds. Otherwise, the pair-matching process would automatically terminate. Optionally, if the sender 103a does not identify a specific receiver 103b from the compiled list, the sender 103a may re-poll the pool of valid receivers 207, in which case the sender 103a would send a second transfer request 201 and a second round of pair-matching would ensue (201 through 206). Re-polling, e.g., a second polling, a third polling, and so forth, can be requested and performed as previously described in connection with the initial pair-matching process.

The pair-matching engine 104 may then present the transfer to the specific receiver 103b, who may have to confirm that he/she desires to receive the transfer 209. Alternatively, confirmation is automatically processed by the receiver's mobile device 105b and/or by the pair-matching engine 104. Once the receiver 103b confirms that he/she desires to receive the transfer 209, the match is finalized and the pair-matching engine 104 informs each of the sender 103a and the specific receiver 103b of the consummation of the match 210. Completion of the transaction further implies that the relevant records of the sender 103a and receiver 103b associated with the first 105a and the second mobile devices 105b are updated. For example, in this instance, in which money was transferred: the amount of the money transferred may be deducted from the sender's account and may be added to the receiver's account.

Whereas the transfer of money involves the exchange of an inanimate object from one to the other, FIG. 3 depicts an example of transferring an animated, interface object from a first mobile device 105a associated with a sender 103a to a matching second mobile device 105b associated with a receiver 103b. In this instance, if both the sender 103a and receiver 103b hold their respective mobile devices 105a, 105b within a certain, pre-defined distance, e.g., immediately next to each other, and each takes an action or makes a gestures, e.g., a finger swipe on the touchscreen, on their respective mobile device 105 simultaneously or within a certain, pre-defined timeframe, relevant information may be collected by the respective user interaction engines 102 running on the mobile devices 105 and may be provided to the pair-matching engine 104 for matching identification as discussed above. Preferably, the time parameter constitutes a measurement of time between recording an action/gesture made on or taken by the sender 103a on the first mobile device 105a and the same or similar action/gesture made on or taken by the receiver 103b on the second mobile device 105b, which may be measured based on the request arriving at the server. As long as the elapsed time between the first action/gesture and the second action/gesture is less than a pre-defined timeframe, then the pair-matching engine 104 may match the sender 103a and receiver 103b. Alternatively, each action/gesture may be individually time-stamped, e.g., by the user interaction engine 102. In this way, when the data are provided to the system 100, the time-stamping of the actions or gestures on each of the two mobile devices 105 can be compared for matching purposes, to ensure that the respective times of occurrence between the two are sufficiently close temporally to “match.”

If a match is found, the animated, interface object 120 is then transferred and removed from the screen of the first mobile device 105a and received, confirmed, and presented on the screen of the second mobile device 105b associated with the receiver 103b. If on the other hand, no match is found between the two mobile devices 105a, 105b, e.g., either of the first 105a or the second mobile device 105b has no network connectivity or the sender 103a and the receiver 103b swiped more than certain period of time apart, the pair-matching engine 104 may notify the two mobile devices 105a, 105b accordingly and the sender 103a or receiver 103b may decide to try again at a later time. Optionally, the sender may re-poll as mentioned briefly above. With the present application having to do with transferring an animate object between mobile devices 105a, 105b and the previous application having to do with transferring an inanimate object between mobile devices 105a, 105b, the number of optional pollings taken may be more or less than those described. Those of ordinary skill in the art can appreciate that the trade-off of greater accuracy in matching is more time and more interactions and input required.

FIG. 4 depicts a non-limiting example of implementation of the engines 102 and 104 depicted in FIG. 1, wherein user interaction engine 102 is implemented via various components on a client device 40 such as a mobile device 105 associated with a user, and pair-matching engine 104 and user record database 110 are implemented via various components on one or more servers 42 running on host device(s). In the example depicted in FIG. 4, the client-server architecture ensures scalability and performance of the system 100 by adopting auto scaling and load balancing features 45 to accommodate traffic spikes and peak hours. The architecture also supports redundancy by creating and dispersing multiple instances of the application, object, or data on different data centers and guaranties 99.95% uptime.

In the example depicted in FIG. 4, HTTPS communication protocol may be utilized to establish secured communication channels between the client devices 40 and the servers 41 with third party CA trusted source validation. The communication between the client devices 40 and the servers 41 may be encrypted, e.g., using Advanced Encryption Standard (AES), and saved encrypted on the servers 41. A log system may also be incorporated to track any abnormalities in the behavior of the app server 42. A monitoring service running on the server 41 may constantly monitor the health of the system 100 and indicate immediately if the server 41 is not working properly. Reports may also be generated, which can be used to monitor and characterize the usage of the system 100 and to improve the configuration of the architecture. Such reports may also be mined for useful data to enable characterization of various phenomena emerging from the movement of the objects or data being transferred between the mobile devices.

### Mobile Payments

In the example of FIG. 1, a mobile transaction engine 106, working together with other engines of the system, enables the sender 103a associated with the first mobile device 105a to conduct a mobile transaction, e.g., transfer money/make payment to, with the receiver 103b associated with the second mobile device 105b by performing an action/gesture on or near the touchscreen 111 of and/or with the first 105a and/or second mobile devices 105b. FIG. 5 depicts a non-limiting example of an implementation of FIG. 1 to support transactions between mobile devices 105 via hand gestures. First, a sender 103a of a financial transaction looks for one or more mobile devices 105b associated with a recipient(s) 103b of the transactions via the user interaction engine 102. Preferably, the sender 103a initiates looking for a desirable match using a hand gesture 108 on an (animated) object or icon representing the corresponding transaction on the touchscreen 111 of the first mobile device 103a, wherein the amount of the transaction is specified by the sender 103a and displayed with the object. Once the parties of the financial transaction, i.e., the sender 103a and one or more recipients 103b, have been identified and matched by the pair-matching engine 104 as discussed above, the sender 103a may then approve the transaction. Subsequently, the object or icon representing the corresponding transaction may then be transferred, accepted, and presented, e.g., as a flying-over icon from the first mobile device, on the screen 111 of the second mobile device 105b associated with the recipient 103b, utilizing the user interaction engine 102 on the recipient's mobile device 105b. If the recipient 103b confirms the acceptance of such financial transaction, mobile transaction engine 106 proceeds to clear the transaction with relevant financial institutions and update the financial records of the both the sender 103a and the recipient 103b accordingly, e.g., by deducting the transferred amount from the sender's account and crediting the same amount to the recipient's account.

In some embodiments, a mobile-web client, e.g., a common web browser running on the mobile device, may be used by the user interaction engine 102 in place of the app to conduct the financial transaction. Preferably, the mobile-web client is also capable of recognizing and accepting actions as well as user's hand/finger gestures, such as one finger touch gesture and two fingers panning gesture; identifying the matching mobile device 105b of the recipient 103b; and verifying the parties 103a, 103b to the financial transaction.

In some embodiments, due to the sensitive nature of the financial transaction, the mobile transaction engine 106 may further implement a transaction code verification process for enhanced security. The transaction code verification process is an additional match verification layer that requires at least one side, e.g., the sender 103a or recipient 103b of the transaction, to enter, i.e., type in, a unique string of pin-code that identifies and starts the financial transaction between the sender 103a and the recipient 103b. Typically, such a pin-code is originated by one party of the financial transaction, and the other party needs to confirm and accept before the transaction can take place. Although the sender 103a is the more logical party to enter the unique string of pin-code, the pin-code may also be input by the recipient 103b. Preferably, the sender 103a approves the transaction with the designated recipient 103b.

FIG. 6 depicts an example of a flowchart of a process to support financial transactions among mobile devices via hand gestures. In the example of FIG. 6, the flowchart 600 starts at block 602 where a sender may initiate a financial transaction using a first mobile device, e.g., to transfer an amount of money specified by the sender to the recipient, via a hand gesture on the touchscreen of the first mobile device. The flowchart 600 continues to block 604 where a second mobile device associated with a recipient of a transaction to be conducted with the sender's first mobile device is identified. The flowchart 600 continues to block 606 where the transaction from the first mobile device is accepted and visually presented on the screen of the second mobile device associated with the recipient. The flowchart 600 continues to block 608 where request for the financial transaction is accepted and the financial transaction is processed by financial institutions. The flowchart 600 ends at block 610 where the relevant financial records related to the sender and the recipient are updated, respectively, once the financial transaction is cleared by the financial institutions.

FIGS. 7A-7N depict a non-limiting example of a step-by-step process of conducting a financial transaction between a sender 103a and a recipient 103b via their associated mobile devices 105a and 105b. The images in FIGS. 7A-7N are meant to depict images displayed on the touchscreen 111 of the sender's mobile device 105a and the recipient's mobile device 105b. Each figure depicts an image displayed on the touchscreen 111 of either the sender's mobile device 105a or the recipient's mobile device 105b. More particularly, FIG. 7A and FIG. 7B show a typical embodiment of a sender's mobile device 105a. In FIG. 7A, an object or icon 80, e.g., a coin, indicates the sender's current account balance of $50.00. A sender 103a may trigger a payment transfer transaction app by performing an action/gesture on or near the touchscreen 11 of the mobile device 105a, e.g., by a finger gesture (e.g., a single tap on the coin object or icon 80). Referring to FIG. 7B, after initiating the transfer transaction app, a prompt may be displayed asking the sender 103a to choose between a business transfer (“pay business”) 81 or a personal transfer (“pay friend”) 82. In the exemplary illustration, the sender 103a may move the coin object/icon 80 up, indicating that the sender 103a desires to “pay a friend” 82. Preferably, as shown in FIG. 7C, once the sender 103a makes his/her choice, a keyboard 83 may appear, e.g., may concurrently slide up from the bottom of the touchscreen 111, to enable the sender 103a to specify an amount to be transferred to the receiver 103b. In a manner that is well known to the art, using the keypad 83, the sender 103a may input the transfer amount 84, e.g., $21.30, further depressing an OK key 89 to initiate the pair-matching process and, ultimately, the transfer transaction.

As described above, the sender's and the recipient's mobile devices 105a and 105b and the pair-matching device 104 operate to find the desired match to effect the person-to-person transaction shown in FIG. 7D. More specifically, the user interaction engine 102 running on the sender's mobile device 105a collects and provides relevant information about the sender 103a and the nature of the desired transaction to the pair-matching engine 104 to identify the sender 103a and/or the sender's account information while also collecting information about available recipients 103b. As previously described, the pair-matching device 104 may use the physical proximity of the parties to the transaction 103a and 103b and/or the temporal spacing of their actions/gestures made on or near the touchscreen 111 of and/or with the mobile device 105a, 105b to identify appropriate matches for the transaction. This first-polling information, as shown in FIG. 7E, may be provided to and displayed on the touchscreen 111 of the sender's mobile device 105a. In FIG. 7E, first-polling display information 85 shows two possible recipients (Robyn and Danny) and, further, suggests that the pair-matching device 104 is still in the process of “finding more friends.” Once the first-polling has been completed and transaction information has been entered, the sender 103a may proactively identify and approve the desired recipient(s) 103b of the transaction, e.g., by taking some action or making some gesture 85a at or near the touchscreen 111 of the sender's mobile device 105a. In the illustrative example, the sender 103a has tapped the touchscreen 111 to indicate the desired recipient 85a, i.e., Robyn. Were only one recipient's name displayed and the recipient 103b approved by the sender 103a, then the transaction may be effected as simply as shown in FIG. 7D and as described in greater detail below.

In some instance, the sender 103a may not be satisfied with the recipient results of the first-polling. Consequently, as shown in FIG. 7F, optionally, the sender 103a may request a second- or additional polling 86 to re-poll available recipients, e.g., by tapping “show all friends” 86a. FIG. 7G shows an illustrative example of possible polling results 87 from a second polling. As with the first-polling, at the conclusion of the second-polling and transaction information has been entered, the sender 103a may proactively identify and approve the desired recipient(s) 103b of the transaction, e.g., by taking some action or making some gesture 85a at or near the touchscreen 111 of the sender's mobile device 105a. As before, the sender 103a has tapped the touchscreen 111 to indicate the desired recipient 87a, i.e., Robyn. Were the results of polling to produce no possible recipients 103b, as shown in FIG. 7H, the pair-matching device 104 may be configured to display a message 88 indicating that there was “no friend found,” further offering the sender 103a an opportunity to select a recipient manually from among his/her contacts. By opting for manual selection 87A, a list of all of the sender's contacts (not shown) may be displayed from which the sender 103a may select a desired recipient(s) 103b.

Having selected and approved a recipient 103b, it remains for the sender 103a to confirm payment, i.e., to approve the transaction (FIG. 7I), to consummate the transaction (FIG. 7J and FIG. 7K), and to confirm transaction consummation and update all accounts accordingly (FIG. 7L and FIG. 7M). For example, after the sender 103a has designated Robyn as the recipient 103b of his/her largesse (FIG. 7G), the mobile transaction engine 106 may be adapted to display a final confirmation message 90 (FIG. 7I) on the touchscreen 111 of the sender's mobile device 105a. The confirmation message 90 may include—for the purposes of illustration and not limitation—a touch bar or button to cancel or abort the transaction (“Cancel”) 91, a touch bar or button to consummate the transaction (“Pay”) 92, a message window 93, e.g., a message to the recipient explaining who the money came from and why, a payment amount 94, and a return (X) key 95. Aborting the transaction may be adapted to return the sender 103a to his/her home screen. Depressing the return (X) key 95 may be adapted to return the sender 103a to the previous screen. The payment amount 94 should be the same as the dollar amount previously entered into the coin object/icon 84. Optionally, a sender 103a may input a personal message to the recipient 103b beforehand, which may appear in a message window 93 provided for that purpose.

After the sender 103a selects 92a the “Pay” button 92, the mobile transaction engine 106 may be configured to send the amount to the recipient's account. As shown in FIG. 7J, the recipient can receive money from a transaction whether he/she is on his/her mobile device's home screen 99 or any other screen 98. Hence, advantageously, the recipient 103b may continue to perform some other action while simultaneously receiving money. In one aspect, as shown in FIGS. 7J and 7L, while the recipient is working on another screen 98, when the recipient's user interaction engine 102 receives the transaction signal from the mobile transaction engine 106, the recipient 103b may receive an alert or notification, i.e., a toast message, that, for example, may identify the sender 103a, and provide the message 93 and the amount if the transfer 94. As shown in FIG. 7N, the recipient 103b may obtain details of the transaction, e.g., by clicking on the alert/toast message, which may cause a drop-down message 129 to be displayed. A “Back” (<) button 121 may be displayed to enable a user to return to a previous state. The alert/notification notifies the recipient 103b that he/she needs to go to his/her home screen 99 and open the appropriate transaction app to consummate the transfer. Once the recipient 103b is on his/her home screen 99 and opens the appropriate app, the conditions are right to consummate the transaction, which is to say, as shown in FIG. 7K, for the sender's user interaction engine 102 to send the money 97 and for the recipient's user interaction engine 102 to receive the money 96.

Confirmation, as shown in FIG. 7L and FIG. 7M, may include the previously described alert/notification messages 93 on the sender's and the recipient's touchscreens 111 and the crediting and debiting of the two accounts. As further shown in FIG. 7M, a transaction notification badge 125 may appear and be displayed on the sender's and the recipient's touchscreens 111. The transaction notification badge 125 may contain some identifier—in this case a Roman numeral 1—that may enable both the sender 103a or the recipient 103b to view transaction data, e.g., in a transaction history database provided for that purpose.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a pair-matching engine, which in operation, identifies a second mobile device associated with a second user in proximity with a first mobile device associated with a first user, wherein the second mobile device is ready to conduct a transaction to transfer an object displayed on the first mobile device to the second mobile device with the first mobile device;
a first user interaction engine running on the first mobile device associated with the first user, which in operation, enables the first user to initiate the transaction via one of a gesture on a touchscreen of and an action with the first mobile device;
a second user interaction engine running on the second mobile device associated with a second user, which in operation,
accepts visually the object transferred from the first mobile device on a screen of the second mobile device;
enables the second user to confirm completion of the transaction.

2. The system of claim 1, further comprising:
a mobile transaction engine, which in operation, updates relevant records of the first and second users associated with the first and the second mobile devices after the transaction is complete.

3. The system of claim 1, wherein:
the object is one of: a virtual software object running and being displayed on the mobile device, a mobile app downloaded to the mobile device, a data payload or file stored in the mobile device, and any other type of electronic information that can be communicated between the mobile devices.

4. The system of claim 1, wherein the object is an animated and/or customizable object.

5. The system of claim 1, wherein:
the object is either transferred directly from the first mobile device to the second device or uploaded to a server first before being downloaded to the second mobile device from the server.

6. The system of claim 1, wherein:
the gesture on the touchscreen is one of swipe, tap, touch, panning, bump, drag and drop by one or more fingers of the first user on the object displayed on the touchscreen.

7. The system of claim 1, wherein:
the first user interaction engine enables the first user to manipulate and interact with the object via at least one of a gesture on the touchscreen and an action with the first mobile device.

8. The system of claim 1, wherein:
at least one of the first user interaction engine and the second user interaction engine collect information from either of the first and second users as well as their associated mobile devices for identifying the second mobile device paired and matched with the first mobile device.

9. The system of claim 8, wherein:
the information collected includes one or more of: locations of the users' mobile devices, the users' gestures on the mobile devices, the users' actions with the mobile devices and the timestamps of the users' gestures.

10. The system of claim 9, wherein:
at least one of the first user interaction engine and the second user interaction engine adjust the accuracy of the location information of the mobile devices used for pairing and matching of the mobile devices based on the locations of the first and second mobile devices.

11. The system of claim 8, wherein:
the pair-matching engine utilizes information collected from the mobile devices to calculate a user vector for each of the mobile devices for pairing and matching purpose.

12. The system of claim 8, wherein:
the pair-matching engine identifies the second mobile device by calculating a spatial distance between the first and the second mobile devices based on the information collected from the mobile devices.

13. The system of claim 8, wherein:
the pair-matching engine identifies the second mobile device by conducting timeframe analysis on the data collected from the mobile devices to calculate a time when at least one of a gesture are made on the touchscreens of the mobile devices and an action is made with the mobile devices.

14. The system of claim 1, wherein:
the pair-matching engine identifies the second mobile device by recognizing different types of user gestures or actions made on the mobile devices and their attributes to establish rules for a successful match between the two mobile devices.

15. The system of claim 1, wherein:
the pair-matching engine compares directions of the gestures made by at least one of the first and the second user to determine the type of action to be taken on the object.

16. The system of claim 1, wherein:
the pair-matching engine dynamically configures at least one of tolerance parameters and error margins for matching of the mobile devices based on a current status of the mobile devices.

17. The system of claim 1, wherein:
the pair-matching engine identifies the second mobile device by utilizing near field communication (NFC) technique for pairing and matching of the mobile devices.

18. The system of claim 1, wherein:
the pair-matching engine identifies the second mobile device in a dense transfer environment where there are many transfers taking place at the same location during the same time window.

19. The system of claim 1, wherein:
the pair-matching engine identifies more than one possible matching mobile devices associated with multiple users that match with the first mobile device.

20. The system of claim 19, wherein:
the user interaction engine presents a list of matching mobile devices to the first user and enables the first user to choose at least one mobile device from the list to proceed with the transfer of the object.

21. A method, comprising:
identifying a second mobile device associated with a second user in proximity with a first mobile device associated with a first user, wherein the second mobile device is ready to conduct a transaction to transfer an object displayed on the first mobile device to the second mobile device with the first mobile device;
enabling the first user to initiate the transaction from the first mobile device via at least one of a gesture on a touchscreen of the first mobile device and an action with the first mobile device;
accepting visually the object transferred from the first mobile device on a screen of the second mobile device;
enabling the second user to confirm completion of the transaction.

22. The method of claim 21, further comprising:
updating relevant records of the first and second users associated with the first and the second mobile devices after the transaction is complete.

23. The method of claim 21, further comprising:
transferring the object by at least one of directly from the first mobile device to the second device and uploading the object to a server before downloading it to the second mobile device from the server.

24. The method of claim 21, further comprising:
enabling the first user to manipulate and interact with the object via at least one of a gesture on the touchscreen and an action with the first mobile device.

25. The method of claim 21, further comprising:
collecting information from the first and second users as well as from their associated mobile devices for identifying the second mobile device paired and matched with the first mobile device, wherein such information includes one or more of: locations of the users' mobile devices, the users' gestures on the mobile devices, the user's actions with the mobile devices, and the timestamps of the users' gestures.

26. The method of claim 25, further comprising:
adjusting accuracy of the location information of the mobile devices used for pairing and matching of the mobile devices based on the locations of the first and second mobile devices.

27. The method of claim 25, further comprising:
utilizing information collected from the mobile devices to calculate a user vector for each of the mobile devices for pairing and matching purpose.

28. The method of claim 25, further comprising:
identifying the second mobile device by calculating a distance between the first and the second mobile devices based on the information collected from the mobile devices.

29. The method of claim 25, further comprising:
identifying the second mobile device by conducting timeframe analysis on the data collected from the mobile devices to calculate the a time when at least one of the gestures are made on the mobile devices and the actions are made with the mobile devices.

30. The method of claim 21, further comprising:
identifying the second mobile device by recognizing at least one of different types of user gestures made on the mobile devices and their attributes and different types of motions made with the mobile devices, to establish rules for a successful match between the two mobile devices.

31. The method of claim 21, further comprising:
comparing directions of the hand gestures made by at least one of the first and the second user to determine the type of action to be taken on the object.

32. The method of claim 21, further comprising:
dynamically configuring at least one of tolerance parameters and error margins for matching of the mobile devices based on a current status of the mobile devices.

33. The method of claim 21, further comprising:
identifying the second mobile device by utilizing near field communication (NFC) technique for pairing and matching of the mobile devices.

34. The method of claim 21, further comprising:
identifying the second mobile device in a dense transfer environment where there are many transfers taking place at a same location during a same time window.

35. The method of claim 21, further comprising:
identifying more than one possible matching mobile devices associated with multiple users that match with the first mobile device.

36. The method of claim 35, further comprising:
presenting a list of matching mobile devices to the first user and enabling the first user to choose one or more mobile devices from the list to proceed with the transfer of the object.
